(19) United States
(12) Patent Application Publication
(10) Pub. No.: US 2013/0201125 A1
(43) Pub. Date: Aug. 8, 2013

(54) METHOD FOR OBJECT ROTATING BY UTILIZING COORDINATE AXIS RATIO AND DIFFERENCE

(71) Applicant: MENG-JU LEE, Tainan City (TW)

(72) Inventor: MENG-JU LEE, Tainan City (TW)

(73) Assignee: HANNSTAR DISPLAY CORP., NEW TAIPEI CITY (TW)

(21) Appl. No.: 13/737,347

(22) Filed: Jan. 9, 2013

(30) Foreign Application Priority Data
Feb. 3, 2012 (CN) 201210024623.3

(51) Int. Cl. G06F 3/041

(52) U.S. Cl. CPC G06F 3/0416
USPC 345/173

(57) ABSTRACT

A method of display rotation by using axis ratio and difference is disclosed. The method includes: performing a first determination step to determine whether or not two touching points exist within an object shown in a screen by using a touch algorithm; if yes, capturing X-coordinate values and Y-coordinate values of the two touching points on an X-axis and a Y-axis respectively; performing a second determination step to determine the touching point with smaller Y-coordinate value as an axle center point and the another touching point with bigger Y-coordinate value as a rotation point; performing a third determination step after the rotation point shifts to rotate object leftward or rightward by using the modulus of the variation of the ratio of the Y-coordinate value to the X-coordinate value of the rotation point and whether the axle center point and the rotation point are located on the X-axis or Y-axis.

### CROSS-REFERENCE TO RELATED APPLICATION

This application claims the benefit of China Patent Application No. 201210024623.3, filed on Feb. 3, 2012, in the State Intellectual Property Office of the People's Republic of China, the disclosure of which is incorporated herein in its entirety by reference.

### BACKGROUND OF THE INVENTION

1. Field of the Invention

The present invention relates to a method for object rotating, and more particularly to a method for object rotating by utilizing coordinate axis ratio and difference determination.

2. Description of the Related Art

Current smart phones are continuously developed to provide more functions and services to satisfy our diversity of demands. Plus user-friendly, overall demands on smart phones are continuously increased to produce more solution means.

Since most displays of smart phones are rectangles, many functions, such as electronic map, satellite positioning navigation, games and the like, need to perform object rotating. In prior arts, a manner of deciding an object rotating uses a variation between two corresponding angles (Φ) to decide the object rotating as shown in FIG. 1. However, the microprocessor in the touch system needs more computation processing to calculate Φ angles, thereby influencing the whole performance.

### SUMMARY OF THE INVENTION

In view of the shortcomings of the prior art, the inventor(s) of the present invention based on years of experience in the related industry to conduct extensive researches and experiments, and finally developed a method for object rotating by utilizing coordinate axis ratio and difference as a principle objective to simplify determining a computation processing required for object rotating, thereby improving the overall performance.

To achieve the foregoing objective of the invention, a method for object rotating by utilizing coordinate axis ratio and difference comprises the following steps: firstly, a first determination step is utilized to determine whether or not two touching points are provided. If two touching points exist, a capture motion is performed, wherein the capture motion includes a microprocessor that respectively captures Y-coordinate values and X-coordinate values of the two touching points on an X-axis and a Y-axis by taking an end point at a lower left side of the screen as an original point, and a second determination step is performed to determine that a smaller Y-coordinate value in the two touching points is an axle center point while a larger Y-coordinate point is a rotation point.

After the rotation point is displaced to a second location from a first location, a third determination step is performed to determine a variation of a ratio (Y/X value) of the Y-coordinate value to the X-coordinate value of the rotation point, wherein the rotation is displaced. If the ratio (Y/X value) of the Y-coordinate value to the X-coordinate value is increased and a modulus of a difference between the ratio in which the rotation point is displaced and the ratio in which the rotation point is not displaced is larger than a set value, the object is left-rotated. The rotation point is displaced. If the ratio (Y/X value) of the Y-coordinate value to the X-coordinate value is decreased and a modulus of a difference between the ratio in which the rotation point is displaced and the ratio in which the rotation point is not displaced is larger than the set value, the object is right-rotated.

In addition, in the second determination step, when the axle center point and the rotation point are simultaneously located at the Y-coordinate axis and the X-coordinate value is 0, the object is right-rotated such that a denominator may not be zero while calculating the ratio of the Y-coordinate value to the X-coordinate value, thereby preventing the computation error from occurring.

When the two touching points are simultaneously located at the X-coordinate axis and Y-coordinate value is 0, the object is left-rotated such that the Y-coordinate value of the two touching points may not be 0, resulting in unable to determine the axle center point and the rotation point.

The method for object rotating by utilizing coordinate axis ratio and difference according to the invention has the following advantages:

While controlling an object rotating, the determination steps of a computation program can be simplified to reduce calculation loading and increase the efficiency.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a schematic diagram of deciding an object rotation using a corresponding angle in prior art;

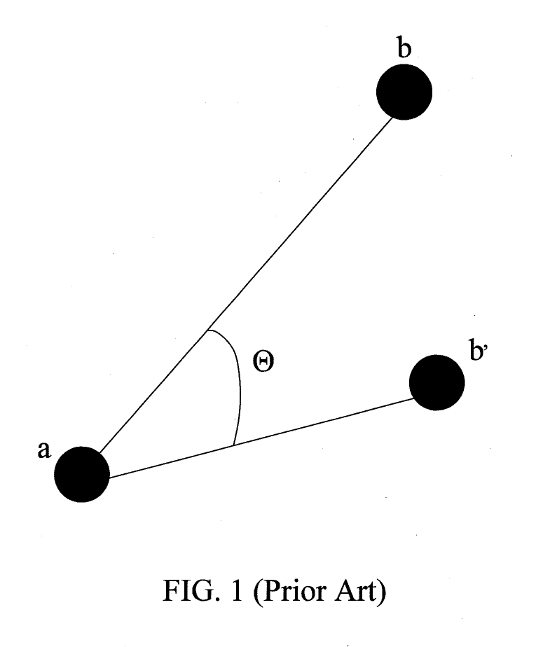

FIG. 2 is a flowchart of a method for object rotating by utilizing coordinate axis ratio and difference according to the invention;

FIG. 3 is a first schematic diagram of a method for object rotating by utilizing coordinate axis ratio and difference according to the invention;

FIG. 4 is a second schematic diagram of a method for object rotating by utilizing coordinate axis ratio and difference according to the invention;

FIG. 5 is a third schematic diagram of a method for object rotating by utilizing coordinate axis ratio and difference according to the invention;

FIG. 6 is a fourth schematic diagram of a method for object rotating by utilizing coordinate axis ratio and difference according to the invention; and

FIG. 7 is a fifth schematic diagram of a method for object rotating by utilizing coordinate axis ratio and difference according to the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

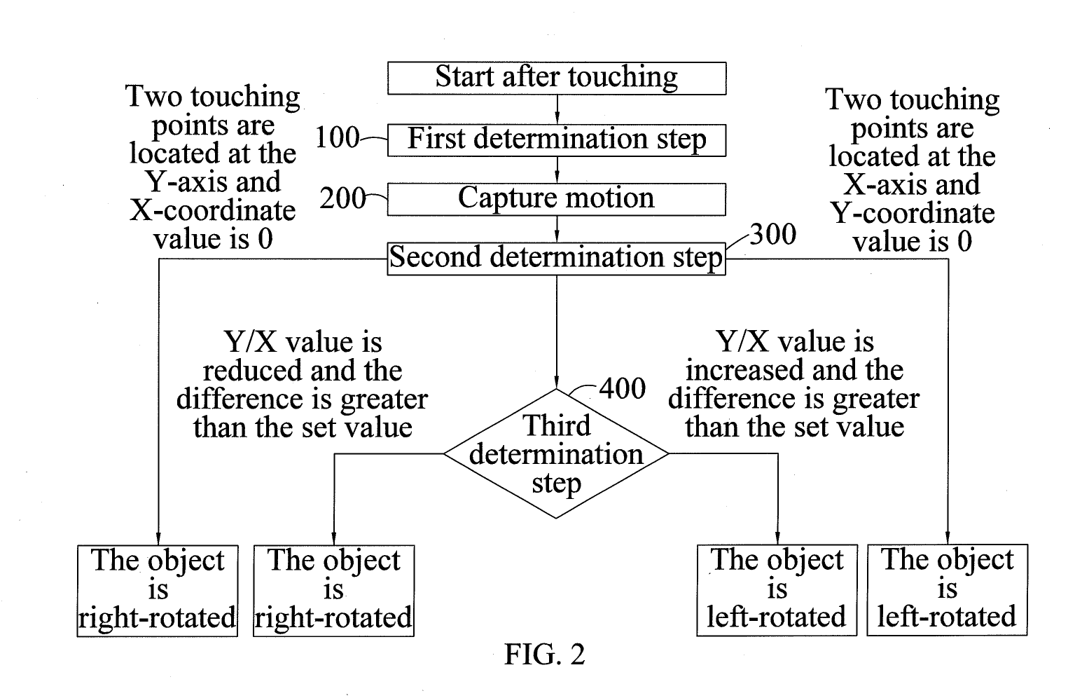

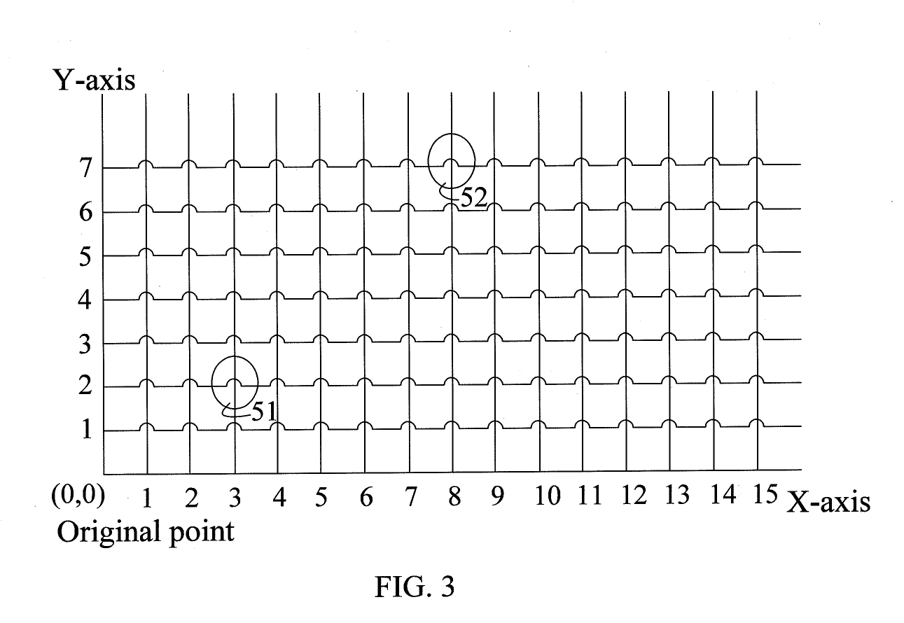

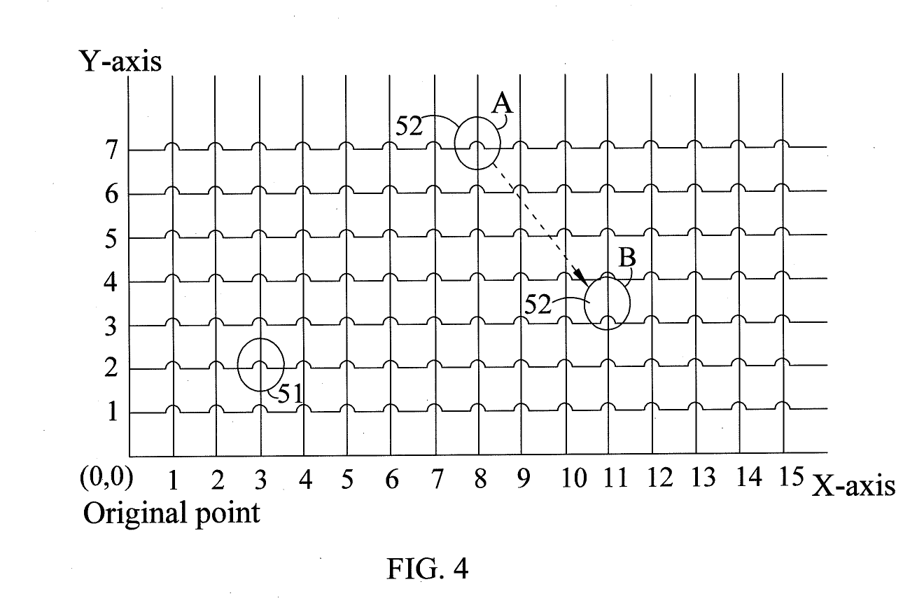

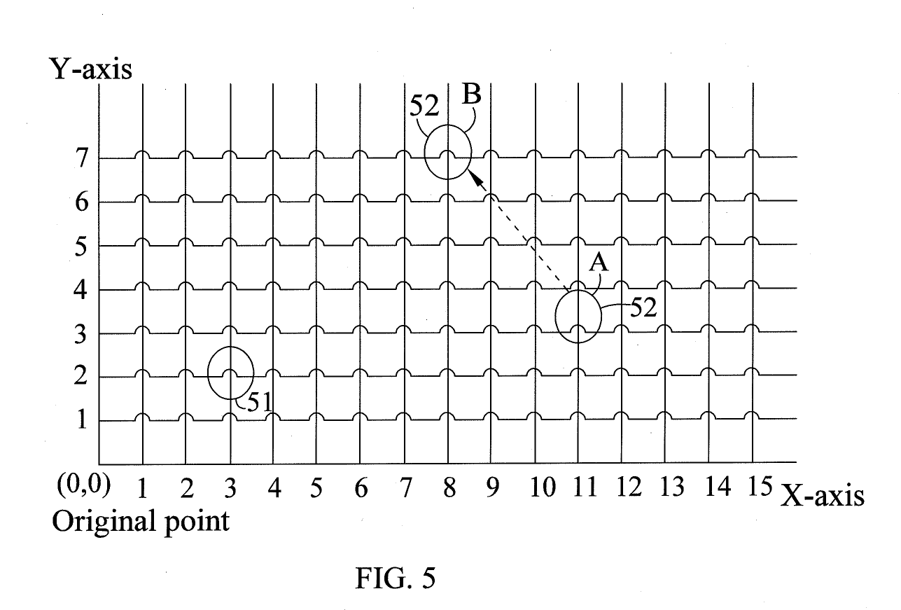

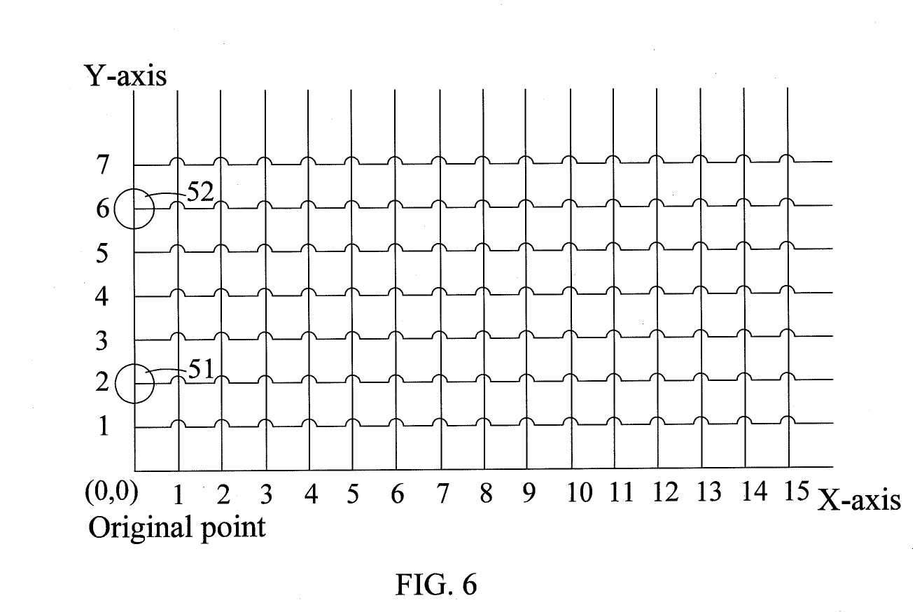

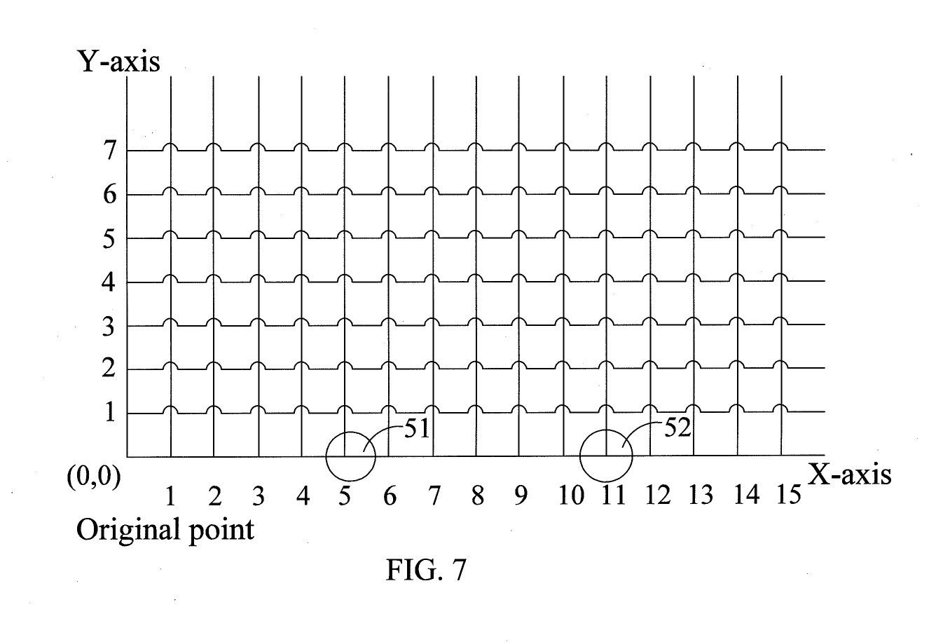

With reference to FIG. 2 to FIG. 7, FIG. 2 is a flowchart of a method for object rotating by utilizing coordinate axis ratio and difference according to the invention. FIG. 3 is a first schematic diagram of a method for object rotating by utilizing coordinate axis ratio and difference according to the invention. FIG. 4 is a second schematic diagram of a method for object rotating by utilizing coordinate axis ratio and difference according to the invention. FIG. 5 is a third schematic diagram of a method for object rotating by utilizing coordinate axis ratio and difference according to the invention. FIG. 6 is a fourth schematic diagram of a method for object rotating by utilizing coordinate axis ratio and difference according to the invention. FIG. 7 is a fifth schematic diagram of a method for object rotating by utilizing coordinate axis ratio and difference according to the invention. In the a method for object rotating by utilizing coordinate axis ratio and difference according to the invention, a step 100 is firstly performed to determine whether or not two touching points exist within an object shown in a screen through a first determination step. If more than two points are touched or a single point is touched on the object through the determination step as well as more than two touching points or a single touching point, next step is not performed. After two touching points existing within the object shown in a screen is determined by the first determination step, subsequent steps are continued. The determination manner adopted by the first determination step, but not limited to, includes a touch algorithm for a touch screen of mobile phone.

Next, if two touching points are touched by the first determination step, a capture motion (step 200) is performed, wherein the capture motion is to capture Y-coordinate values and X-coordinate values of the two touching points through the microprocessor. For example, the microprocessor takes an end point at a lower left side of the screen as an original point to respectively capture Y-coordinate values and X-coordinate values of the two touching points touched on the object and performs a second determination step (step 300) to determine that one touching point of the two touching point is an axle center point and another touching point of the two touching points is a rotation point. As shown in FIG. 3, a smaller Y-coordinate value in the two touching points is the axle center point 51 while a higher Y-coordinate value is a rotation point 52.

In addition, when a third determination step (step 400) is performed after the rotation point 52 rotates to a second location B from a first location A. Taking a ratio of the Y-coordinate value of the rotation point to the X-coordinate value as Y/X value, a modulus of variance of a difference between Y/X value at the second location B and Y/X value (a ratio of Y-coordinate value to X-coordinate value) at the first location A for the rotation point is determined (step 400). Specifically, when Y/X value of the rotation point at the second location B is greater than the Y/X value of the rotation point at the first location A, the Y/X value of the rotation point is gradually increased, and if the modulus of variation of the Y/X value of the rotation point is greater than a set value, object left rotation motion is performed, wherein the range of the set value can, but not limited to, be between 0.2 and 0.8. Similarly, when the Y/X value of the rotation point at the second location B is smaller than the Y/X value of the rotation at the first location A, the Y/X value of the rotation point is gradually reduced. If the modulus of the variation of the Y/X value of the rotation point is greater than the set value, object right rotation motion is performed. The range of the set value can, but not limited to, be between 0.2 and 0.8. For example, as shown in FIG. 4, suppose the coordinate of the first location A is (8, 7) and the coordinate of the second location B is (11, 3). When the rotation point 52 is moved to the second location B from the first location A, the Y/X value of the rotation point 52 is changed to 3/11 from 7/8. In another word, the Y/X value of the rotation point 52 is reduced. The modulus of the variation that subtracts the Y/X value of the rotation point at the second location B from the Y/X value of the rotation point at the first location A will be greater than the set value 0.5. Therefore, it is determined that the object needs to be right-rotated, and the object right rotation motion is performed. As shown in FIG. 5, suppose the coordinate of the first location A is (11, 3) and the coordinate of the second location B is (8, 7). When the rotation point 52 is moved to the second location B from the first location A, the Y/X value of the rotation point 52 is changed to 7/8 from 3/11. The Y/X value of the rotation point 52 is increased, and the modulus of the variation that subtracts the Y/X value of the rotation point 52 at the first location A from the Y/X value of the rotation point at the second location B will be greater than the set value 0.5. Therefore, it is determined that that the object needs to be left-rotated, and the object left rotation motion is performed.

When a posture function displays that the two touching points are at Y-coordinate axis as well as the X-coordinate value of the two touching points that is 0. To prevent an error caused by the computation where the denominator is zero during the calculation of the Y/X value, it is directly determined that the object is right-rotated and performs the object right rotation motion. Similarly, when the posture function displays that the two touching points are at the X-coordinate axis as well as the Y-coordinate value of the two touching points is 0. To avoid the axle center point and the rotation point that are unable to be determined due to the same Y-coordinate value of the two touching points, it is directly determined that the object is left-rotated and performs the object left rotation motion. For example, as shown in FIG. 6, when the axle center point 51 and the rotation point 52 are located at the Y-coordinate axis as well as the X-coordinate value that is 0, it is directly determined that the object is right-rotated and the object right rotation motion is performed. As shown in FIG. 7, for example, when the axle center point 51 and the rotation point 52 are located at the X-coordinate axis as well as the Y-coordinate value is 0, it is directly determined that the object is left-rotated and the object left rotation motion is performed.

The advantage of the method for object rotating by utilizing coordinate axis ratio and difference is that a determination process is simplified by using the ratio of the coordinate axis and the difference. After capturing the Y-coordinate value and the X-coordinate value, the result can rapidly reacted through the simplified determination manner of the invention, and resources required for computation can be reduced.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A method for object rotating by utilizing coordinate axis ratio and difference comprising:
performing a first determination step to determine whether or not two touching points are provided through a touch algorithm;
executing a capture motion to respectively capture Y-coordinate values and X-coordinate values of the two touching points on an X-axis and a Y-axis if the two touching points are provided, and executing a second determination step to determine whether one touching point of the two touching points is an axle center point and another touching point of the two touching points is a rotation point; and
executing a third determination step to determine a modulus for a variation of a ratio (a Y/X value) of the Y-coordinate value to the X-coordinate value of the rotation point or whether the rotation point and the axle center point are located on the X-axis or the Y-axis to perform an object left rotation motion or an object right rotation motion if the rotation point is displaced.

2. The method for object rotating by utilizing coordinate axis ratio and difference as recited in claim 1, wherein the capture motion is to capture the Y-coordinate value and the X-coordinate value of the two touching points through a microprocessor.

3. The method for object rotating by utilizing coordinate axis ratio and difference as recited in claim 1, wherein the Y-coordinate value of the axle center point is smaller than the Y-coordinate value of the rotation point.

4. The method for object rotating by utilizing coordinate axis ratio and difference as recited in claim 1, wherein after the rotation point is displaced, the ratio of the Y-coordinate value to the X-coordinate value of the rotation point is reduced, and the a modulus of a variation of the ratio of the Y-coordinate value to the X-coordinate value of the rotation point is greater than a set value, and the object right rotation motion is performed.

5. The method for object rotating by utilizing coordinate axis ratio and difference as recited in claim 4, wherein the variation of the ratio of the Y-coordinate value to the X-coordinate value of the rotation point is a difference that subtracts the ratio of the Y-coordinate value to the X-coordinate value of the rotation point, which is not displaced yet, from the ratio of the Y-coordinate value to the X-coordinate value of the rotation point which is displaced.

6. The method for object rotating by utilizing coordinate axis ratio and difference as recited in claim 1, wherein after the rotation point is displaced, the ratio of the Y-coordinate value to the X-coordinate value of the rotation point is increased, and the a modulus of a variation of the ratio (Y/X value) of the Y-coordinate value to the X-coordinate value of the rotation point is greater than the set value, and the object left rotation motion is performed.

7. The method for object rotating by utilizing coordinate axis ratio and difference as recited in claim 6, wherein the variation of the ratio of the Y-coordinate value to the X-coordinate value of the rotation point is the difference that subtracts the ratio of the Y-coordinate value to the X-coordinate value of the rotation point, which is not displaced yet, from the ratio of the Y-coordinate value to the X-coordinate value of the rotation point which is displaced.

8. The method for object rotating by utilizing coordinate axis ratio and difference as recited in claim 1, wherein in the second determination step, if the two touching points are simultaneously located at the Y-coordinate axis and the X-coordinate value is 0, the object right rotation motion is performed.

9. The method for object rotating by utilizing coordinate axis ratio and difference as recited in claim 1, wherein in the second determination step, if the two touching points are simultaneously located at the X-coordinate axis and the Y-coordinate value is 0, the object left rotation motion is performed.
